(19) United States
(12) Patent Application Publication
(10) Pub. No.: US 2006/0284728 A1
(43) Pub. Date: Dec. 21, 2006

(54) Pulse width modulation data transfer over commercial and residential power lines method, transmitter and receiver apparatus

(75) Inventors: Francis M. Rubinstein, Pinole, CA (US); Peter Pettler, Nevada City, CA (US)

Correspondence Address: MCNICHOLS RANDICK O'DEA & TOOLIATOS, LLP, 5000 HOPYARD ROAD, SUITE 400, PLEASANTON, CA, 94588, US

(73) Assignee: The Regents of the University of California

(21) Appl. No.: 11/472,583

(22) Filed: Jun. 21, 2006

Related U.S. Application Data
(60) Provisional application No. 60/692,752, filed on Jun. 21, 2005.

(51) Int. Cl. G05B 11/01

(52) U.S. Cl. 340/310.12; 375/344; 375/257; 315/291

(57) ABSTRACT

A method and apparatus for data transfer over existing or newly installed residential or commercial power lines is comprised of a transmitter and receiver unidirectionally communicating by phase cutting a portion of the received carrier voltage supply so as to receive a digital signal of low bandwidth. The resulting communication method is known as phase cut carrier, or PCC. The phase cut carrier communication method is shown to be able to addressably communicate lighting level commands for various types of lighting. In other embodiments, the phase cut carrier method may be used to control the powered status of addressably or nonaddressably controlled equipment.

### CROSS REFERENCE TO RELATED APPLICATION

This application claims priority under 35 USC 119 and 35 USC 120 to U.S. Provisional Patent Application Ser. No. 60/692,752 filed on Jun. 21, 2005 and entitled “PULSE WIDTH MODULATION DATA TRANSFER OVER COMMERCIAL AND RESIDENTIAL POWER LINES METHOD, TRANSMITTER AND RECEIVER APPARATUS”.

### STATEMENT REGARDING FEDERAL FUNDING

This invention was made with U.S. Government support under Contract Number DE-AC03-76SF00098 between the U.S. Department of Energy and The Regents of the University of California for the management and operation of the Lawrence Berkeley National Laboratory. The U.S. Government has certain rights in this invention.

### REFERENCE TO A COMPUTER PROGRAM

Not applicable.

### BACKGROUND OF THE INVENTION

1. Field of the Invention

The present invention pertains generally to methods used in relatively low baud rate data communication, more particularly to data communication transmitted over previously embedded power lines, and still more particularly to data communication transmitted over previously embedded power lines using phase cut carrier techniques to devices having low or no current draw during a portion of the power line alternating voltage cycle.

2. Description of the Relevant Art

U.S. Pat. No. 4,876,498, issued Oct. 24, 1989, hereby incorporated by reference, discloses a method of light dimming by variation of the RMS voltage supply.

U.S. Pat. No. 4,954,768, issued Sep. 4, 1990, hereby incorporated by reference, discloses a method of light dimming by variation of the RMS voltage supply, but includes a modification to eliminate potentially harmful DC bias voltages supplied to a light producing device.

U.S. Pat. No. 5,107,184, issued Apr. 21, 1992, hereby incorporated by reference, discloses a method of light dimming control by half-cycle modulation of the voltage supply. In this method, entire half-cycles of the supply voltage are interrupted to provide a low baud rate digital data transmission useful for light level control.

U.S. Pat. No. 5,872,429, issued Feb. 16, 1999, hereby incorporated by reference, discloses a method of light dimming control by encoded modulation of the supply voltage. In this coding method, a selected perturbation, such as a phase cut, is imposed on the nominal waveform with a respective occurrence signature within a control period. Such control period includes a pre-selected number of fundamental periods of the input voltage signal. The perturbations provide a signal useful for light level control.

U.S. Pat. No. 6,037,722, issued Mar. 14, 2000, hereby incorporated by reference, discloses a light dimming fluorescent lamp ballast, potentially compatible with this invention.

U.S. Pat. No. 6,172,466, issued Jan. 9, 2001, hereby incorporated by reference, discloses a light dimming fluorescent lamp ballast, controlled by an input voltage waveform having a portion of the waveform phase up to 15°, and output intensity of the fluorescent lamp proportional to the amount of phase removed.

U.S. Pat. No. 6,208,126, issued Mar. 27, 2001, hereby incorporated by reference, discloses a circuit having a bi-directional switch for supplying a load from an AC voltage supply, and controlled by a relatively low voltage DC control line.

U.S. Pat. No. 6,218,787, issued Apr. 17, 2001, hereby incorporated by reference, discloses a system for controlling the output intensity of a fluorescent lamp based on receiving a slightly asymmetric input AC voltage over existing building wiring.

U.S. Pat. No. 6,229,271, issued May 8, 2001, hereby incorporated by reference, discloses a low harmonic distortion line dimmer and dimming ballast system for controlling the output intensity of a fluorescent lamp, based on receiving a pulse-width-modulated input AC voltage over existing building wiring.

U.S. Pat. No. 6,316,883, issued Nov. 13, 2001, hereby incorporated by reference, discloses a power factor correction.

U.S. Pat. No. 6,351,080, issued Feb. 26, 2002, hereby incorporated by reference, discloses a simplified circuit useful for a dimmable electronic fluorescent lamp ballast.

U.S. Pat. No. 6,400,098, issued Jun. 4, 2002, hereby incorporated by reference, discloses a compact fluorescent light dimmer which functions by transmitting pulses of the RMS voltage supply to the lighting load.

U.S. Pat. No. 6,538,395, issued Mar. 25, 2003, hereby incorporated by reference, discloses a current controlled light dimmer for controlling the output intensity of a fluorescent lamp with a magnetic ballast.

### BRIEF SUMMARY OF THE INVENTION

One embodiment provides for a method of transmitting information over power lines, the method comprising: a) cutting a portion of a voltage phase of an alternating current (AC) power line to provide a transmitted binary digit (bit), said voltage cutting step produced by a transmitter; b) receiving the transmitted bit on a receiver in direct electrical communication with said AC power line; c) decoding a series of transmitted and received bits as information; and d) outputting one or more signals based on the decoded bit information as a signal output.

Another embodiment is where said cutting portion of the phase occurs in either or both of the positive and negative voltages. Other applications include: a) applying one or more of the signals to turn a light on or off; b) applying one or more of the signal outputs to vary an intensity of a light. The outputting step output signal(s) may be directed to control an output intensity of a light selected from a group containing: high intensity discharge (HID) lamps, fluorescent lamps, light emitting diodes (LEDs), incandescent lamps, halogen, or other electrically controlled lighting source. Additional non-lighting devices may be controlled that have a phase-cut-compatible low to no current draw during a portion of the power supply alternating voltage cycle. Yet more devices may be controlled if they are designed so that they have sufficient energy storage capacity to draw low to no current during at least one half voltage cycle on a periodic basis.

In some embodiments, the cutting portion of the phase may be controlled by a microprocessor, and the method may be used where said cutting portion of the phase occurs during a portion of the AC voltage where little or no current is drawn by a device controlled by said signal output. The resulting device may be used wherein said signal output turns a device controlled by said signal output to an “On” or and “Off” state.

In the preceding embodiment, cutting step bit produces a plurality of bits during one half voltage cycle of the AC power line, where said outputting step signal output further comprises a data structure of address bits and data value bits.

Alternatively the previous embodiments may be practiced by comparing said data packet of address bits with a preset address for a device, and if said data packet address bits select said preset address for said device, then applying said data value bits to control said device.

Another alternative embodiment is an apparatus for communicating information over power lines, said apparatus comprising: a) a transmitter, said transmitter cutting a portion of a voltage phase of an alternating current (AC) power line to provide a transmitted binary digit (bit); b) a receiver in electrical communication with said AC power line, said receiver receiving the transmitted bit; c) decoding a series of transmitted and received bits as information; and d) outputting one or more signals based on the decoded bit information.

Still another embodiment is a phase cut transmitter apparatus for transmitting information over power lines, said apparatus comprising: a transmitter, said transmitter cutting a portion of a voltage phase of an alternating current (AC) power line to provide a transmitted binary digit (bit). Furthermore, said cut portion of said voltage phase reduces said voltage phase to less than 30, 10, 3, 1, 0.300, 0.100, 0.030, 0.010, 0.003, or 0.001 VAC when there is a load attached to said transmitter.

Typically, said cut portion of said voltage phase is cut during the portion of the alternating current power line wherein low or no current is flowing, in such a manner that said low or no current cut dissipates power in a cutting circuit a level below 30, 10, 3, 1, 0.300, 0.100, 0.030, 0.010, 0.003, or 0.001 W during a one second time period.

In still another embodiment, an apparatus is disclosed for receiving phase cut information over power lines, said apparatus comprising: a) a receiver attached to, or capable of being in electrical communication with an alternating current (AC) power line providing a phase cut transmitted binary digit (bit), said receiver receiving the transmitted bit; b) an information packet comprised of a series of one or more transmitted and received bits; and c) one or more output signals based on the information packet. In this embodiment, said phase cut transmitted (bit) occurs in either or both of the positive and negative voltages of the AC power line. The resulting device can control a light capable of being turned on or off by one or more of the output signals, or a light capable of varying output intensity by one or more of the output signals. Such light may be selected from a group containing: high intensity discharge (HID) lamps, fluorescent lamps, light emitting diodes (LEDs), incandescent lamps, halogen, or other electrically controlled lighting source.

A microprocessor may be used for detecting and outputting one or more of the output signals. In the device, said phase cut transmitted binary digit (bit) occurs during a portion of the AC voltage where little or no current is drawn by a device controlled by said output signal. Such control may be used to output signals to turn the device to an “On” or “Off” state. In another embodiment a plurality of said phase cut transmitted binary digits (bits) occur during one-half voltage cycle of the AC power line.

In wye or delta 3 and 4 wire AC power supply applications, phase cut signal transfer may be detected by monitoring of a dedicated signal leg relative to another leg, or all lines may be sequentially or simultaneously monitored for a simpler installation. In a preferred embodiment, such monitoring only barely increases the complexity of the receiver printed circuit board, with additional scaled voltages monitored either directly by a suitable microprocessor capable of voltage measurement, or multiplexed into such microprocessor, said multiplexer typically a CMOS switch controlled by said multiplexer or time sequenced by simple clocking circuit.

In still another embodiment, said information packet further comprises a data packet of address bits and data value bits, with or without framing start and/or stop bits as is typical of serial data communications devices. In another embodiment, a device may be controlled by said data value bits when a preset address for said device is selected by said address bits.

### BRIEF DESCRIPTION OF THE SEVERAL VIEWS OF THE DRAWINGS

The invention will be more fully understood by reference to the following drawings, which are for illustrative purposes only:

FIG. 1 is an idealized current and voltage waveform for an electronic ballast or similar electronic device.

FIG. 2 is a segment of a voltage waveform showing encoding of a 1-0-0-1 byte by: briefly interrupting the voltage to the leftmost voltage half cycle to create a slot that is cut into the waveform, thus impressing a “1” on that half cycle waveform, the next two half wave cycles have no slots cut and therefore encode two digital “0's”, and finally, the rightmost half cycle shows a slot encoded to a “1”.

FIG. 3 is a circuit diagram of a typical power factor correction device coupled with a dimmable electronic fluorescent ballast and lamp.

FIG. 4 is a circuit diagram of one implementation of a phase cut carrier encoder, alternatively referred to as a transmitter.

FIG. 5A is a circuit diagram of one implementation of a phase cut carrier decoder, alternatively referred to as a receiver.

FIG. 5B is a photograph of the circuit diagram of FIG. 5A showing one implementation of a phase cut carrier decoder/receiver compared with a U.S. quarter.

FIG. 6 is a house wiring diagram of a lighting distribution panel feeding three or more room or zone dimmable fluorescent lamp ballasts.

FIG. 7 is an illustration of a room/zone multi-level switching system for control of multiply-ballasted fluorescent fixtures.

### DETAILED DESCRIPTION OF THE PREFERRED EMBODIMENT

Defined Terms

“AC” means alternating current that reverses direction periodically, usually many times per second, and usually with a typically sinusoidal voltage waveform.

“Bit” means a binary digit.

“Phase Cut Carrier” means interrupting sections of an AC power line, so as to convey information to one or more load devices powered by the AC power line.

“Cutting” means interrupting normal AC.

“Computer” means any device capable of performing the steps developed in this invention to result in a power line carrier encoder or decoder, including but not limited to: a microprocessor, a microcontroller, a digital state machine, a field programmable gate array (FGPA), a digital signal processor, a collocated integrated memory system with microprocessor and analog or digital output device, a distributed memory system with microprocessor and analog or digital output device connected with digital or analog signal protocols. For the purposes of this application, computer and microprocessor will be used interchangeably.

“Computer readable media” means any source of organized information that may be processed by a computer to perform the steps developed in this invention to result in a power line carrier encoder or decoder, including but not limited to: a magnetically readable storage system; optically readable storage media such as punch cards or printed matter readable by direct methods or methods of optical character recognition; other optical storage media such as a compact disc (CD), a digital versatile disc (DVD), a rewritable CD and/or DVD; electrically readable media such as programmable read only memories (PROMs), electrically erasable programmable read only memories (EEPROMs), field programmable gate arrays (FGPAs), flash random access memory (flash RAM); and remotely transmitted information by electromagnetic or optical methods.

“Voltage phase” means a voltage observed on an AC power line. The voltage phase typically varies sinusoidally with positive and negative voltages about a near-zero average value relative to a ground line.

“Signal” means any electromagnetic emission capable of detection.

“Power” means the product of voltage times current.

Introduction

The devices described herein use a method for transmitting control commands over two conductors (typically the line and neutral conductors) of a two wire lighting branch circuit wiring during device-dependent portions of an alternating current (AC) power supply waveform when there is low or no current flowing. The technique may be adapted to control fluorescent and high intensity discharge (HID) lamps that are operated with electronic ballasts, but may also be used with many other remotely controlled devices having low or no current draw during a portion of their power supply waveform. The invention uses a synchronous electronic switch to digitally impress coded perturbations (modulations) on the downstream voltage waveform of the branch circuit by grounding, or cutting, the power supply voltage during portions of the waveform when there is little or no current: thus the phrase “Phase Cut Carrier”. These perturbations can represent dimming commands for lighting fixtures that are connected on the branch.

A receiver, or decoding module, installed in each fixture to be controlled, interprets digitally encoded signals as commands from the power line branch circuit, and varies the fixture's dimming level in response to each command.

The Phase Cut Carrier modulating technique typically results in an improved signal-to-noise ratio when compared to traditional additive high frequency carrier signal modulation utilized by conventional Power Line Carrier (PLC) techniques. As a result, communication errors are minimized without the need for resorting to complex statistical encoding/modulation schemes (e.g. spread spectrum). Also, unlike other techniques, the invention physically confines the control signals to an electrical region downstream of their point of injection.

The performances of conventional PLC schemes tend to suffer from unpredictable attenuation of their high frequency carrier signals as transmitted over the in-place power lines. This limitation is substantially overcome by momentarily interrupting, or cutting, one or more small “slices” of the 50 or 60 Hz supply voltage waveform at the instant when zero (or very low) current is flowing. It is preferably that little or no current flowing is due to: 1) the heat dissipation and heat sinking capabilities of the interrupting, or cutting, device components; and 2) introduction of increased harmonic distortion of the AC power supplied to devices attached down the circuit branch powered through the transmitting or encoding device. The phase cutting power components preferably used here are Field Effect Transistors (FETs) with relatively low on resistances, preferably of 0.07 ohms RDSₒₙ or less, but ultimately limited only by power dissipation heat transfer and heat capacity design considerations. These sliced perturbations are readily conducted over the power line infrastructure. The technique is designated as Phase Cut Carrier (PCC) to differentiate it from the conventional PLC technique. Additional low pass circuitry or pulse forming networks may readily be provided to reduce power line electromagnetic or radio frequency (EMI/RFI) emissions due to slice transitions.

The technology described herein is useful for sending control commands to any electrical device that exhibits certain current waveform properties. Specifically, the invention will likely work well on any electrical device that exhibits a current waveform that is zero (or low) for a fraction of the waveform time period. Nearly all electronically ballasted fluorescent lamps (including compact fluorescent lamps) and most high intensity discharge (HID) lamps exhibit these current waveform properties, and could therefore be controlled using the technology described herein. Solid-state light sources (i.e., light emitting diodes, LEDs) may also be controlled, as well as electronic transformers for incandescent lamps, including halogen lamps.

A large number of products outside of the lighting category likely have compatible electrical current waveform properties that could be controlled using PCC. In particular, devices with high power factors will typically have close alignment between current and voltage, such as pulsed power supplies for a variety of equipment. When such supplies are used under conditions below their maximum output power and lowest input line voltage, portions of the voltage supply will have periods of low to no current draw. Such power supplies would be readily adapted to incorporation of Phase Cut Carrier unidirectional, or simplex, communications.

By increasing the instantaneous and average power handling capacities of the cutting components, the phase cut carrier could be used up to the maximum of the power available in the input supply.

Although the Phase Cut Carrier method and apparatus has many potential applications, the instant example application is for lighting control.

Background

Lawrence Berkeley National Laboratory Disclosure and Record of Invention, entitled “Phase Cut Carrier: A Method for Transmitting Information over Electric Wiring” further explains the invention described herein, is attached hereto, and is hereby incorporated by reference in its entirety. Component data sheets, attached hereto and incorporated by reference in this application for one embodiment of the invention utilizing multifunction programmable microcontrollers (see definition for computer above) for a low parts count implementation, include: a Siemens Electromechanical Components data sheet for IAC/OAC, IDC/ODC Input/Output Modules; and Cypress MicroSystems CMS10002A-R3.14 entitled “CY8C25122, CY8C26233, CY8C26443, CY8C26643 Device Data Sheet, 8-Bit Programmable System-on-Chip (PsoC™) Microcontrollers”.

Lawrence Berkeley National Laboratory publication LBNL-49975, entitled “High Performance Commercial Building Systems”, incorporated herein by reference, and attached hereto, describes methods of light dimming using an Integrated Building Environmental Communications System (IBECS). The IBECS system, however, requires additional control lines to be installed in existing buildings, and is therefore not as economical as using already installed power lines for communication due to high costs of retrofit installation of such control lines. IBECS is further explained with Lawrence Berkeley National Laboratory report LBNL-49973, entitled “IBECS Network/Ballast Interface Final Report”, which is attached hereto and hereby incorporated by reference in its entirety.

The IBECS system, in turn, uses a digital trim potentiometer (colloquially referred to as a “trim pot”), the DS2890, for light level control. Dallas Semiconductor “DS2890 1-Wire® Digital Potentiometer”, appears as an appendix in report LBNL-49973 above, and thus is already incorporated by reference and attached hereto, describes operation of the DS2890 trim pot, which is easily adaptable to the decoder herein as a digitally controlled voltage or current output signal to act as an input for light dimming control, thereby adapting exiting voltage controlled light level control systems to the communication invention described herein.

Light dimming of fluorescents is described in the Philips Semiconductors Application Note “AN10181_{—}01: 36W TLD application with UBA2014”, which is hereby incorporated by reference. By suitable incorporation of this invention, fluorescent light dimming may be accomplished by modulation of the frequency of high voltage discharge through the fluorescent light tube from 3-100% illumination. Other lighting systems may be entirely shut off by properly powering the trim pot to both positive and negative voltages to produce a negative voltage; in some systems, application of a negative voltage operates to completely shut the device off.

Phase Cut Carrier (PCC) Method and Apparatus for Lighting Control

One embodiment of the present invention is a method for transmitting control commands over two conductors (typically the line and neutral conductors) of building electric wiring systems. The PCC method is particularly well suited to the control fluorescent and high intensity discharge (HID) lamps that are operated with electronic ballasts. The apparatus components comprise (at least) two physically separate parts: 1) an encoding module (or transmitter) that digitally impresses coded information onto the electric wiring, and 2) one or more decoding modules (or receivers) that are directly electrically connected to each load to be controlled.

The encoding module uses an electronic switch to digitally impress coded voltage perturbations (i.e. a coded voltage modulation) on the downstream voltage waveform of an electrically switched circuit. These perturbations, which may or may not be synchronous, represent dimming commands that control the decoding modules connected to the lighting fixtures electrically downstream of the encoding module. The decoding module(s), which are installed on each circuit branch of fixture(s), or ballast(s), to be controlled, interpret the commands and vary light levels accordingly.

This modulating technique, which is termed Phase Cut Carrier (PCC), results in an improved signal-to-noise ratio when compared to the additive high frequency carrier signal modulation utilized by conventional Power Line Carrier (PLC) techniques. The performance of conventional PLC schemes suffers from the unpredictable attenuation of their high frequency carrier signals when transmitted over the in-place electric wiring.

As described herein, rather than injecting high frequency information as is done with PLC methods, one or more small “slices” of the 60 Hz supply voltage waveform are momentarily interrupted, or “cut.” During periods of data transmission in a preferred digital embodiment, each half cycle of the voltage waveform constitutes one or more binary “bits” of information, with a stream of bits forming a message packet. Each half cycle is either “sliced”, labeling it a binary “1”, or left untouched, labeling it a “0”. These momentary interruptions are readily conducted over the building's electrical wiring because the frequency of encoding is the same order of frequency as the voltage supply. This situation is very favorable to reliable transmission of information along electric power wires, in contrast to PLC where the frequency of encoding is several orders of magnitude higher (typically 200-400 kHz) than the frequency of the AC voltage supply (50-60 Hz). Also, unlike other techniques, the disclosed technology physically confines the control signals to downstream of their point of injection.

Alternatively, if, for the particular device to be controlled, there is a sufficiently long period of low or no current flow, a plurality of slices may be made in each half cycle of the voltage waveform, and slices may be synchronously or asynchronously spaced during one or both half cycles. In this manner, a higher baud rate of communication may be implemented. For example, with 10 slices in a positive half-cycle, a simplex version analogous to RS232 serial data communications is possible, at a baud rate of 600 bits per second on a 60 Hz power system. The data structure of each half cycle would be a start bit, eight bits of data, and a stop bit for asynchronous data transmission, and four to eight bits of data for synchronous data.

In yet another embodiment, the Phase Cut Carrier (PCC) communication method to provide data flow from the encoder to the decoder resident on the device to be controlled may be complemented by a return data communication loop such as an infrared (IR) signal returning to a suitable IR detector in communication with the encoder. Such duplex coupling provides for closed loop communication between devices in a control loop. Closed loop coupling of the devices back to a PCC-enhanced power distribution junction box may then be used for load control in regions where power demand billings places differential premiums on power use at different times of the day, and/or day of the week, or on overall peak power demand.

The PCC technology can be implemented with relatively low-cost electronic circuitry utilizing low-power programmable embedded processors. Only relatively primitive computational routines are required, mainly comprising only voltage measurement, interval measurements, and serial data manipulation. This permits an implementation of PCC with minimal circuitry and very low cost (and low power) embedded microprocessor chips.

With additional computational complexity, additional existing and future power line control methods could be used with the decoder disclosed herein. Examples where the disclosed PDD Decoder would also be usable include, without exclusion: 1) forward phase dimming, where a portion of each half cycle after the zero crossing is cut; 2) reverse phase dimming, which passes the portion of each half cycle after the zero crossing, then cuts the portion thereafter to the next zero crossing; 3) phase angle dimming; 4) half wave cutting formats, where a deleted half wave signals the beginning or end of a data state, and the number of intervening half waves is used as the data; and 5) any other defined power line carrier voltage modulation method that can be suitably monitored with tracking software.

While for the example case of lighting control it would be natural to combine a dimmer control with a PCC encoder, the PCC encoder electronics is sufficiently small that it could be included in standard-sized circuit breakers for control of various circuit branches.

Many data formats, both digital and analog, can be accommodated using PCC. Many of these additional formats can be used with additional cost and complexity. For example, PCC has been adapted for the transmission of low baud rate analog information. Other coding schemes may be used with this invention using analog, digital, or mixed transmission methods.

PCC is most readily used for electrical devices that exhibit certain current waveform properties. Specifically, the PCC works best on electrical devices that exhibit a current waveform that is near zero (or low, hence low or no current) for a fraction of the waveform time period. Nearly all electronically ballasted fluorescent lamps and high intensity discharge (HID) lamps exhibit the required current waveform properties, and can therefore be controlled using PCC. Alternatively, with thermally managed increased power dissipation, other devices may be controlled when there is higher current flowing during the phase cut. By temporally spreading out such phase cuts, thermal dissipation of the encoder is reduced, and obtrusive interference with down line powered devices is minimized.

Method of Operation

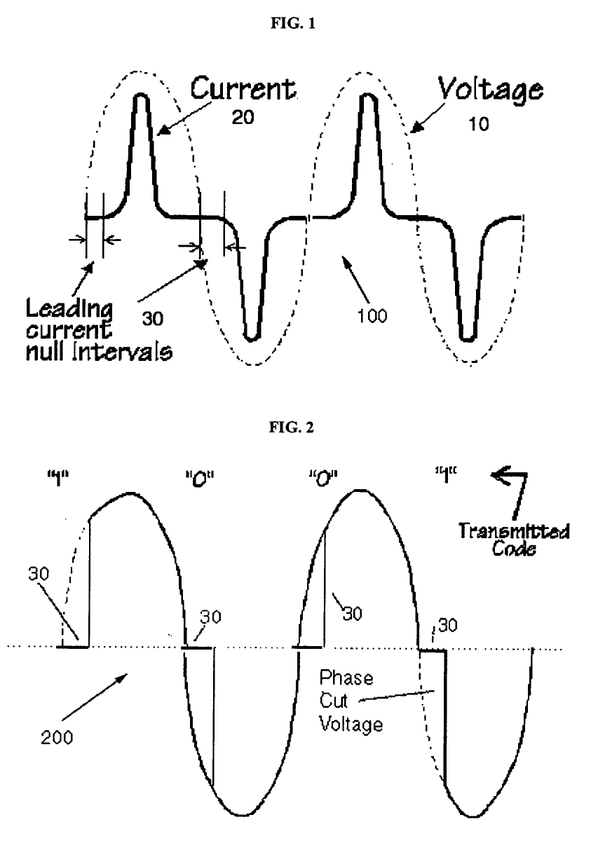

In the absence of power factor correction circuitry, the idealized power line current and voltage waveforms 100 in an electronic ballast can be illustrated as indicated in FIG. 1. The voltage curve 10 is indicated by the dashed trace, with the current curve 20 indicated by the solid trace.

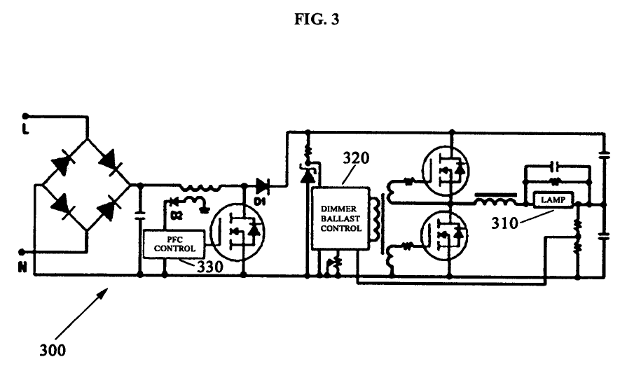

The annotation in FIG. 1 points to the interval 30 at the leading edge of each half-cycle voltage waveform where only a small value of line current is drawn by the ballast. During this interval when low or no current is being drawn, a half cycle of the voltage waveform can be tagged by having a slot cut into it. It can be assumed that if the voltage waveform were slotted only during that interval, it would have negligible effect on the operation of the ballast or the rest of the electric supply. Experimental measurements have verified this assumption in several instances. It then follows that it is feasible to use switching of the voltage waveform for one-way transmission of either continuous or periodic data (which may be used for information or commands) onto the power line. In the case of transmitting digital data, one possible encoding scheme is illustrated in FIG. 2.

Note that if the leading edge of each voltage alternation (or half cycle) is momentarily interrupted, a digital “1” is sent down the branch. Conversely, in those instances where the voltage waveform is unmodified, a digital “0” is sent downstream. FIG. 2 shows using only one waveform “slot” in the leading edge of each half wave. At the cost of some slight additional software complexity, it will also be possible to utilize a slot in the trailing edge and/or to subdivide each of these slots into sub-intervals.

Power Factor Correction

Generic electronic lighting ballasts typically utilize “off-line” capacitor input power supplies to derive their operating voltages. The basic circuit constituents of such a supply are illustrated in FIG. 3 with a typical schematic 300 for a power factor controlled dimming lamp 310 powered by a dimmer ballast controller 320.

The PFC (Power Factor Correction) controller 330 serves to instantaneously vary the current from the power mains to track the shape of the line voltage waveform. In the absence of the PFC, the line current would have a very peaked non-linear characteristic as illustrated in the FIG. 1 current waveform 20. This would result in excessive THD (Total Harmonic Distortion) and a poor power factor. To overcome these issues, either passive or active PFC circuitry is included in almost all electronic ballasts, and frequently in computer power supplies. The PCC data transmission scheme will likely operate successfully with many electronic ballasts, and other electronic devices, regardless of whether or not they incorporate power factor correction circuitry.

In the case of ballasts equipped with a PFC controller 330, the slot in the voltage waveform is sensed by the corrective current control loop PFC controller 330, which attempts to momentarily force the line current to zero, following the instantaneous shape of the voltage waveform. The net result is the same as the non-PFC case, except that the current perturbations only occur randomly for the instant that a “1” is being transmitted, and then only for brief intervals measured in milliseconds. Furthermore, in actual practice the digital command codes are transmitted only whenever a new dimming level is sent to the downstream decoders. The net effect on the lighting branch power quality power is miniscule and should have little operational impact on overall power quality.

Phase Cut Carrier Demonstration

An engineering feasibility model of PCC dimming and multi-level switching control was successfully demonstrated at the Lawrence Berkeley National Laboratories. Two types of lighting fixture decoders were included in the demonstration and were shown to be capable of simultaneous operation on a common lighting branch circuit: one decoder controlled a conventional 0-10 VDC dimmable ballast (Mark VII from Advance Transformer) installed in a light fixture, while the second illustrated four level control of three lamps (simulated by three LEDs mounted on the decoder).

TABLE 1
Encoder Parts List

| Quantity | Reference Locator | Manufacturer/Part Number | Distributor/Part Number | Value |
|---|---|---|---|---|
| 1 | BOX801 | enclosures and cases.com | context 3008 H | 3008 |
| | | 3008, 5″ + H | | |
| 1 | C801 | Kemet C320C474M5U5CA | Digi-Key 399-2159-ND | 0.47 uF |
| 1 | C802 | Panasonic ECA-1EM102 | Digi-Key P5156-ND | 1000 uF |
| 3 | C803, C805, C807 | Kemet C317C104M5U5CA | Digi-Key 399-2143-ND | 0.1 uF |
| 3 | C804, C810, C811 | Panasonic ECQ-U2A225ML | DigiKey P10738-ND | 2.2 uF |
| 2 | C808, C812 | Panasonic ECA-1VM101 | Digi-Key P5165-ND | 100 uF |
| 1 | C809 | Panasonic ECA-1HM471 | Digi-Key P5185-ND | 470 uF |
| 1 | D805 | generic | generic | 1N4006 |
| 2 | D806, D807 | generic | generic | 1N4742A |
| 5 | D808, D809, D815, | IR 11DQ05 | Digi-Key 11DQ05-ND | 11DQ05 |
| | D816, D817 | | | |
| 1 | D810 | generic | generic | 1N4732A |
| 1 | D811 | generic | generic | 1N4749A |
| 1 | D814 | generic D0-35 | generic | 1N4148 |
| 1 | D801V277 | 1.5KE220CA | Mouser 511-1.5KE220CA | 1.5KE220AC |
| 1 | D803V277 | 1.5KE300CA | Mouser 511-1.5KE300CA | 1.5KE300AC |
| 1 | D804V117 | 1.5KE220CA | Mouser 511-1.5KE220CA | 1.5KE220AC |
| 1 | FH801 | Wickmann 830835 | Digi-Key WK0006-ND | 830 |
| 1 | F801V117 | Wickmann 1941800000 | Digi-Key WK2069-ND | 1941800000 |
| 1 | F801V277 | Wickmann 1941400000 | Digi-Key WK2062-ND | 1941400000 |
| 1 | J801 | Do Not Install | Pads Only | 22AWG on .25 |
| 1 | K801 | P&B RTD14012F | Digi-Key PB292-ND | RTD14012F |
| 1 | P801 | Do Not Install | Pads Only | AMP 644456-5 |
| 2 | Q801, Q803 | Infineon SPW47N60C2 | Digi-Key SPW47N60C2IN-ND | SPW47N60C2 |
| 1 | Q804 | Generic | Generic | 2N7000 |
| 2 | Q801V277, | IR IRFPE50 | Digi-Key IRFPE50-ND | IRFPE50 |
| | Q803V277 | | | |
| 2 | R801, R803 | ⅛ W 1% | generic | 510 ohm |
| 1 | R802 | ½ W 5% | generic | 160K |
| 2 | R804, R822 | ⅛ W 1% | generic | 1M |
| 1 | R805 | ⅛ W 1% | generic | 60.4 ohms |
| 6 | R806, R807, R815, | ⅛ W 1% | generic | 10K |
| | R816, R820, R827 | | | |
| 4 | R810, R813, R814, R821 | ⅛ W 1% | generic | 100K |
| 2 | R811, R812 | ⅛ W 1% | generic | 330 Ohm |
| 1 | R817 | ¼ W 1% | generic | 620K |
| 2 | R818, R819 | ⅛ W 1% | generic | 62K |
| 1 | R823 | ½ W 5% | generic | 1 ohm |
| 3 | R824, R825, R826 | ⅛ W 1% | generic | 1K |
| 4 | SO1, SO2, SO3, SO4 | #2-56 .187 long hex thru | Mouser 534-1797A | stand-off |
| | | thread | | |
| 1 | SW801 | Grayhill 76SB02S | Digi-Key GH1002-ND | 76SB02S |
| 1 | T801 | PPC/Magnetek CSE187-L | Digi-Key 237-1103-ND | CSE187-L |
| 1 | T802 | Tamura PFT6-32 | Digi-Key MT1129-ND | PFT6-32 |
| 1 | U801 | NEC PS2501-4 | DigiKey PS2501-4-ND | PS2501-4 |
| 1 | U802 | NJR NJM78M05FA | Digi-Key NJM78M05FA-ND | NJM78M05FA |
| 1 | U803 | Cypress CY8C26443-24PI | Digi-Key 428-1428-ND | CY8C26443- |
| | | | | 24PI |
| 1 | U804 | DIP | generic | 74HC04 |
| 1 | U805 | TI TLV2374IN | Digi-Key 296-12221-5-ND | TLV2374IN |
| 1 | U807 | NJR NJM78M12FA | Digi-Key NJM78M12FA-ND | NJM78M12FA |
| 1 | W801 | Alpha 1561-1, 22 AWG solid | 22 AWG solid | PVC White 6″ |
| 1 | W803 | Alpha 1561-2, 22 AWG solid | 22 AWG solid | PVC Black 6″ |
| 1 | W805 | Alpha 1561-6, 22 AWG solid | 22 AWG solid | PVC Orange |
| | | | | 6″ |
| 1 | W807 | Alpha ? | 22 AWG stranded | PVC Yellow |
| | | | | 6″ |
| 1 | W809 | Alpha ? | 22 AWG stranded | PVC Blue 6″ |
| 1 | W811 | Alpha 1561-7, 22 AWG solid | 22 AWG solid | PVC Brown 6″ |
| 1 | W814 | Alpha ? | 22 AWG stranded | PVC Red 6″ |
| 1 | XU803 | Machine Screw 28 × 0.3 | generic | 28 × .3Socket |
| 1 | X801 | 6 rows of Mill-Max 853-93- | Mouser 575-003101 | part of 853-93- |
| | | 100-10-001000 | | 100-10-001000 |
| 2 | ZZ801, ZZ802 | NTE TP0010 | Allied 935-6527 | Thermal Pad |
| 4 | ZZ803, ZZ804, ZZ805, | #2 .032 thick .25 dia | Mouser 561-D232 | Flat Washer |
| | ZZ806 | | | |
| 4 | ZZ807, ZZ808, ZZ809, | 2-56 ½″ | Mouser 5721-256-½ | Flat Pan Head |
| | ZZ810 | | | Screw |
| 4 | ZZ811, ZZ812, ZZ813, | 2-56 normal | Mouser 5721-256 | Nut |
| | ZZ814 | | | |

Encoder

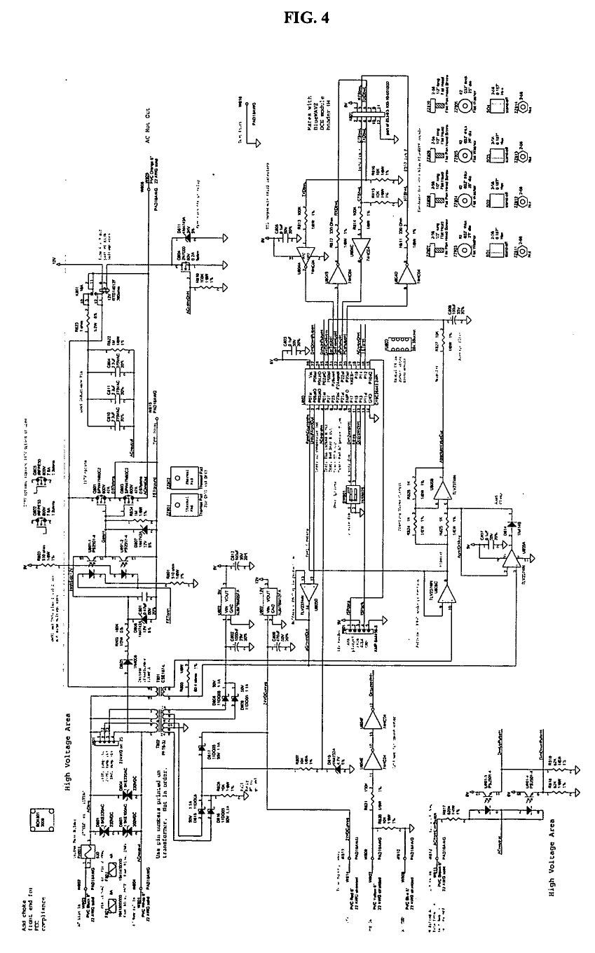

The schematic for one embodiment of the encoder (or transmitter) is shown in FIG. 4. An associated component parts list is found in Table 1 above. Referring now to FIG. 4, the input AC Hot In and AC Neutral In ultimately connect to the AC power mains external to the schematic. AC Hot In is fused appropriately to the line voltage input. The AC Line In and AC Neutral In power transformers T801 and T802. T802 has low voltage taps 8, 9, and 10, which are half bridge rectified through D815 and D816 to provide a 24 V DC unregulated power supply signal 24VDCunreg, which is used as input to voltage regulator U807 to produce a 12 V DC regulated supply voltage. T802 taps 5, 6, and 7 are likewise used with diodes D808 and D809, and regulator U802 to provide a regulated 5 V DC supply voltage. T802 taps 6 and 9 and joined to provide a common low voltage ground.

T801 is used for measurement of the AC Hot In current, or input line voltage, with tap 5 used as an analog ground, and tap 6 used for current measurement. Taps 5 and 6 connect to R805, which acts as a load to produce a voltage proportional to the input line current. T801 tap 6 is buffered by U805C to prevent high voltage transient spikes, and proceeds with the raw AC current input signal RawACcurrentIn into an operational amplifier (op-amp) half wave regulator formed by op-amps U805A, U805B, diode D814, and associated resistors, to form an absolute value of the load current signal, Absolute ValueCur.

Microprocessor U803 is capable of being connected to an external controller via RS232 by interconnection with NAND gates U804A-D and associated resistor networks. U803 samples the ACSignalIn and AbsoluteValueCur (sampled as CurDCvalueIn) signals to determine how much power is being drawn through AC Hot In. U803 further samples DimUpPulseH and DimDownPulseH to determine whether the device(s) further down the AC Hot Out branch circuit need to change state up or down. In lighting applications, DimUpPulseH and DimDownPulseH relate purely to lighting levels. Software within the microprocessor U803 samples DimUpPulseH and DimDownPulseH levels, and compares these levels to a current level. With this comparison made, U803 outputs a Phase Cut Carrier signal on AC Hot Out by resistively breaking the connection between ACLineIn and AC Hot Out with signal FETOnH, which switches optoisolators U801-1 on and U801-2 off. The optoisolators, in turn, pull GateH high, switching FETs Q801 and Q803 on, passing ACLineIn to ACHotOut though resistances of 0.07 ohms. When a phase cut carrier signal is desired, FETOnH is pulled low, turning off the power FETS Q801 and Q803, interrupting ACHotOut, and allowing it to be drawn to a low voltage.

Should the power factor of AC Hot In be substantially less than unity as measured by microprocessor U803, ACrelayOnH is output, turning on FET Q804, and in turn actuating relay K801. K801 connects a capacitive network between ACneutral and AC Hot Out, correcting the power factor for predominantly inductive loads.

Signals DimUpPulseH and DimDownPulseH are formed in the following manner. External switches S1 and S2 respectively connect the positive or negative ACline (a fused and spike protected version of AC Hot In) input half cycles through opto isolator U801-3 and U801-4 with signal ACfromDimSwitch. When a positive ACfromDimSwitch voltage is present, U801-3 forms an NPN pullup to 5 V, and otherwise is grounded. When a negative ACfromDimSwitch optoisolator voltage is present, U801-4 forms an active NPN pullup to 5 V, and otherwise is grounded.

By appropriate software configuration of U803, the encoder may be made to output phase cut carrier signals of ten bits per positive AC Hot Out half signal with low power dissipation on FETs Q801 and Q803. Since output current and voltage are known through real-time measurements of U803, as is the on resistance from drain to source (R_{DSon}=0.07 Ω) instantaneous power dissipation in the output FETs may be calculated. By using this instantaneous dissipation multiplied by the duration of the phase cuts, average and peak power dissipations may be kept to thermally compatible safe levels.

Alternative, or additional coding of the microprocessor U803 could allow emulation of silicon controlled rectifier (SCR)-type dimmers, TRIAC-type dimmers, dimmers using half cycle cutting (where entire half cycles are deleted from AC Hot Out). In a preferred embodiment, the encoder could be switched from one dimming style to another dimming style via initial setup switches read by the microprocessor U803, with robust software allowing many alternative encoding schemes. Such flexibility of dimming method would allow for one dimming controller to be preset for several controller alternatives, reducing the number of unit types needed for dimming applications, and ideally becoming a “generic” dimmer controller.

Decoder

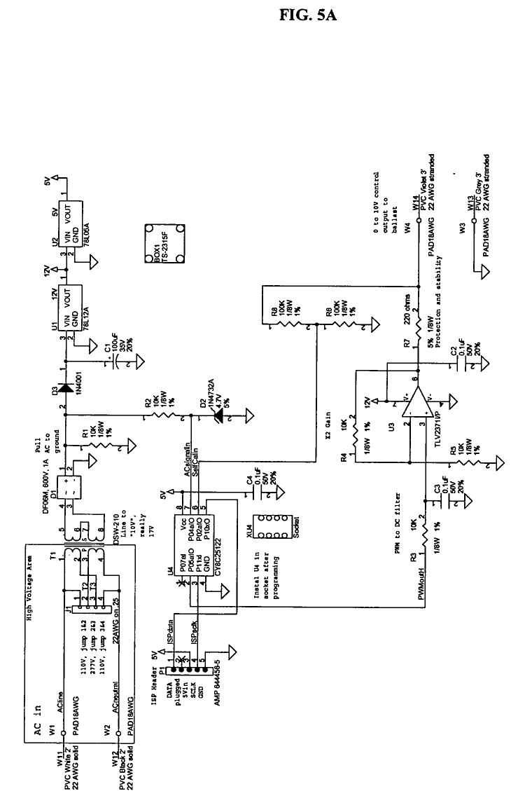

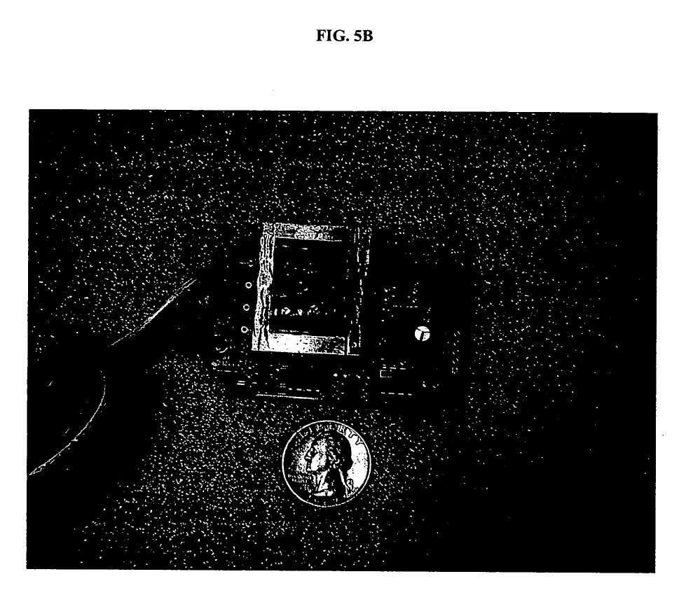

Refer now to FIG. 5A, the schematic for the decoder, which is much simpler than the preceding encoder of FIG. 4. Branch power enters in ACline and ACneutral, which are appropriately jumpered to line transformer T1 for a 17 V AC output to full bridge rectifier D1. The rectifier D1 output is used as input power to U1, a 12 V DC voltage regulator. U2, a 5 V DC regulator is in turned powered by the prior 12 V DC supply. U4 is a microprocessor powered by the 5 V supply. The microprocessor U4 has an ACsignalin input connected to the output of the 17 V AC output of full bridge rectifier D1. In an alternative, unshown embodiment, T1 taps 3 and 4 are level shifted and scaled for measurement by U4 as an alternate ACsignalin input, allowing for phase cut carrier signal on both positive and negative half cycles of the input AC line.

Microprocessor U4 samples the ACsignalin input to determine which, if any, phase cut carrier signaling method is being used for lighting control. By appropriate software control of microprocessor U4, many of the traditional light dimming methods employing two-wire phase cut carrier techniques could be used as a carrier signaling method, as previously discussed. Additionally, the decoder may be self-configuring by repeatedly sampling the ACsignalin to detect which method of dimming is being utilized.

Once microprocessor U4 has determined the method of sampling being employed, an output control voltage PWMoutH is output to an RC network of R3 and C3, which acts as a low pass filter having a relatively stable voltage at their juncture. This relatively stable output signal voltage is used as an input to op amp U3, which is configured as a 2× multiplier. The op amp U3 output signal voltage is a 0-10 V DC control voltage that may be used for control on three-wire dimmable lamp devices. The op amp U3 (which also has an internal voltage reference) output voltage is in turn divided by a factor of two by a resistor network R6 and R8, and the quotient monitored by microprocessor U4 as signal SelfCalin. Under software control, the SelfCalin signal level can be compared with the level desired with PWMoutH, and the pulse width modulator adjusted accordingly up or down in pulse frequency to achieve the desired output control voltage. One example of a voltage controlled dimming device is the Advance Transformers Mark VII three-wire dimmable lamp ballast.

Refer now to FIG. 5B, which is a photograph of a prototypically decoder module reference in size to a United States quarter dollar. With reduction of size of the transformer, the size of the decoder is expected to decrease significantly.

Application of PCC to Control of Fluorescent Lamps

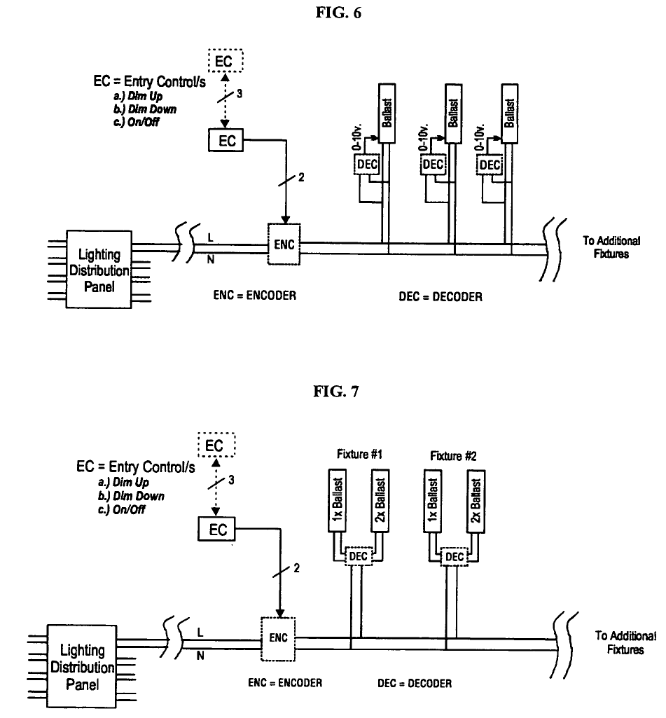

The PCC technology described here can be applied to the control of lighting systems in several different ways. In one embodiment, the encoder would be mounted in or attached to the electrical junction box that is usually located in the ceiling above the room wall switch. As shown in the FIG. 6, the existing wall box would be replaced with entry controls (EC) allowing the room occupant to control the operation of the encoder, and therefore the lights, by adjusting a familiar wall switch that provides input to an encoder (ENC) described herein. Instead of carrying normal power on-off voltages, pulses would be sent to control lighting levels. For example, an up signal would be comprised of one or more positive half cycles. Similarly, a down signal would be comprised of negative half cycles. These signals would be used as inputs to the encoder to increment the lighting levels appropriately. The ENC would be inserted between the lighting distribution panel and the group of ballasts providing lighting for a common area, thereby allowing control of the common area lighting. Each fixture to be controlled (dimmed) would need to be refitted with commercially available 0-10 VDC dimmable ballast and a decoder that would be located at the input to the fixture's ballast. Note that the installation of the PCC technology does not require the installation of additional control wiring or access to the ceiling plenum. This is useful in retrofit applications where access to the ceiling plenum is usually cost-prohibitive.

Similarly, for stepped-dimming (or multi-level lighting) systems, decoders would be installed at the input to each ballast group to be switched as shown in FIG. 7. In the example of FIG. 7, there are two ballast groups, Fixture #1 and Fixture #2. The fixture sets, comprised in this example of one 1× ballast and one 2× ballast, are controlled by one decoder for each fixture set.

Retrofit Lighting Control

A common technical problem is how to reliably send control signals from an electrical junction box to fluorescent and high intensity discharge (HID) lamp ballasts over the in-place lighting branch circuit wiring without compromising the performance of the electrical distribution system.

In existing buildings, it is advantageous from the standpoint of energy efficiency and improved occupant satisfaction to retrofit overhead lighting systems with dimmable lighting components (specifically, ballasts) that are controlled from a wall switch or other location, preferably (but not necessarily) over existing wiring. This proposition is typically not cost-effective today in the majority of buildings because dimmable lighting has previously required running additional control wiring that is both difficult and expensive to retrofit into existing buildings. The relatively high cost of installing control wiring has thus far been one of the factors hindering the penetration of energy efficient lighting controls into the market. With the technology described herein, it is possible to communicate with and to control fluorescent and HID lamp ballasts without the need to install additional control wiring.

Power line carrier (PLC) is another technique that has been used to communicate with building loads over in-place building electric wiring. Power line carrier has technical attributes that limit its usefulness for controlling devices over building electric wiring systems. The performance of conventional PLC schemes suffer from the unpredictable attenuation of their high frequency carrier signals as transmitted over the in-place wiring.

Conclusions

1. All publications, patents, and patent applications mentioned in this specification are herein incorporated by reference to the same extent as if each individual publication or patent application were each specifically and individually indicated to be incorporated by reference.

2. The description given here, and best modes of operation, are not intended to limit the scope of this application. Many modifications, alternative constructions, and equivalents may be employed without departing from the scope and spirit of the technology.

We claim:

1. A method of transmitting information over AC power lines, the method comprising:
a) cutting a portion of a voltage phase of an AC power line to provide one or more transmitted bits, said voltage cutting step produced by a transmitter;
b) receiving one or more of the transmitted bits, on a receiver in direct electrical communication with said AC power line, as received bits;
c) decoding, in the receiver, the received bits as decoded bit information; and
d) outputting one or more signals based on the decoded bit information.

2. The method of claim 1 wherein said cutting portion of the voltage phase occurs in either or both of a positive and negative voltage.

3. The method of claim 1 further comprising the step of:
a) applying one or more of the signals to turn a light on or off.

4. The method of claim 1 further comprising the steps of:
a) applying one or more of the signal outputs to vary an intensity of a light.

5. The method of claim 1 wherein said outputting step is directed to control an electrically controlled device.

6. The method of claim 1 wherein said cutting portion of the phase is controlled by a microprocessor.

7. The method of claim 1 wherein said cutting portion of the phase occurs during a portion of the AC voltage where little or no current is drawn by a device controlled by said signal output.

8. The method of claim 1 wherein said signal output turns a device controlled by said signal output to an “On” state.

9. The method of claim 1 wherein said signal output turns a device controlled by said signal output to an “Off” state.

10. The method of claim 1 wherein said cutting step bit produces a plurality of bits during one half voltage cycle of the AC power line.

11. The method of claim 1 wherein said outputting step signal output comprises a structured data packet of address bits and data value bits.

12. The method of claim 11 further comprising:
a) comparing said structured data packet address bits with a preset address for a device, and if said data packet address bits select said preset address for said device, then applying said data value bits to control said device.

13. An apparatus for communicating information over power lines, said apparatus comprising:
a) a transmitter, said transmitter able to provide one or more transmitted binary digits (bits) by a correspondence of cut portions of a voltage phase of an alternating current (AC) power line;
b) a receiver in electrical communication with said AC power line,
i) wherein said receiver receives the transmitted bit, decodes a series of transmitted and received bits as information; and outputs one or more signals based on the decoded bit information.

14. A phase cut transmitter apparatus for transmitting information over power lines, said apparatus comprising:
a) a transmitter, whereby said transmitter cuts a portion of a voltage phase of an alternating current (AC) power line to provide a transmitted binary digit (bit).

15. The apparatus of claim 14, wherein said cut portion of said voltage phase reduces said voltage phase below a voltage selected from a group consisting of: 20 VAC, 10 VAC, 5 VAC, and 2 VAC.

16. The apparatus of claim 14, wherein said cut portion of said voltage phase is cut during the portion of the alternating current power line wherein low or no current is flowing.

17. The apparatus of claim 16, wherein said low or no current cut dissipates power in a cutting circuit to a level during a one second time period below one of the group consisting of: 30, 10, 3, 1, 0.300, 0.100, 0.030, 0.010, 0.003, and 0.001 W.

18. An apparatus for receiving phase cut information over power lines, said apparatus comprising:
a) a receiver in electrical communication with an alternating current (AC) power line to transmit a phase cut transmitted binary digit (bit), said receiver to receive the transmitted bit;
b) a data structure comprised of a series of one or more transmitted and received bits; and
c) one or more output signals based on the information packet.

19. The apparatus of claim 18 wherein said phase cut transmitted (bit) occurs in either or both of the positive and negative voltages of the AC power line.

20. The apparatus of claim 18 further comprising:
a) a light capable of being turned on or off by one or more of the output signals.

21. The apparatus of claim 18 further comprising:
a) a light capable of varying output intensity by one or more of the output signals.

22. The apparatus of claim 21 wherein said light is selected from a group containing: high intensity discharge (HID) lamps, fluorescent lamps, light emitting diodes (LEDs), incandescent lamps, halogen, or other electrically controlled lighting source.

23. The apparatus of claim 18 further comprising:
a) a microprocessor to detect one or more of the transmitted bits and output one or more of the output signals based upon the data structure.

24. The apparatus of claim 18 wherein said phase cut transmitted binary digit (bit) occurs during a portion of the AC voltage where little or no current is drawn by one or more devices controlled by said output signal.

25. The apparatus of claim 18 wherein said output signal turns a device controlled by said signal output to an “On” state.

26. The apparatus of claim 18 wherein said output signal turns a device controlled by said signal output to an “Off” state.

27. The apparatus of claim 18 wherein a plurality of said phase cut transmitted binary digits (bits) occur during one half voltage cycle of the AC power line.

28. The apparatus of claim 18 wherein said information packet further comprises a data packet of address bits and data value bits.

29. The apparatus of claim 28 further comprising:
a) a device controlled by said data value bits when:
i) a preset address for said device is selected by said address bits.

30. An apparatus for receiving phase cut information over power lines, said apparatus comprising:
a) a receiver in electrical communication with an alternating current (AC) power line that provides phase cut information;
b) a microprocessor that samples the phase cut information to detect a method of phase cut information transmission; and
c) one or more output signals based on the phase cut information and the method of phase cut information transmission.

31. The apparatus of claim 30 wherein the method of phase cut information transmission is selected from a group consisting of: forward phase dimming; reverse phase dimming; phase angle dimming; half wave dimming format; and phase cut carrier dimming.

32. A phase cut carrier encoder, comprising:
a) means for encoding phase cut carrier signals on an AC power line.

33. A phase cut carrier decoder, comprising:
a) means for decoding phase cut carrier signals on an AC power line.

34. A phase cut carrier simplex data communication system, comprising:
a) means for encoding phase cut carrier signals on an AC power line;
b) means for decoding phase cut carrier signals produced by said means for encoding on said AC power line.

35. A phase cut carrier data structure transmitted over AC power line, comprising:
a) an address word; and
b) a data word.

36. The data structure of claim 35 wherein said address word is comprised of one or more bits.

37. The data structure of claim 35 where said data word is comprised of one or more bits.

38. The data structure of claim 35 where said address and data words are transmitted over one or more voltage cycles of said AC power line.

39. A phase cut carrier transmitter to interrupt an AC power line voltage comprising:
a) a microprocessor to detect and record an instantaneous power use over one or more cycles in an AC power line;
b) two or more normally on field effect transistors controlled by said microprocessor, and passing said instantaneous power to said AC power line; and
c) a program in said microprocessor with instantaneous power limit;
d) whereby a phase cut is effected by said microprocessor during execution of said program during a time in said AC power line cycle where an average of said recorded instantaneous power use is below said instantaneous power limit, said phase cut effected by an output signal from said microprocessor to turn off said normally on field effect transistors.
